(19) United States
(12) Patent Application Publication
(10) Pub. No.: US 2015/0136541 A1
(43) Pub. Date: May 21, 2015

(54) VARIABLE BRAKING SYSTEM

(71) Applicant: Hyundai Motor Company, Seoul (KR)

(72) Inventor: SungJun HAN, Gunpo-si (KR)

(73) Assignee: Hyundai Motor Company, Seoul (KR)

(21) Appl. No.: 14/497,076

(22) Filed: Sep. 25, 2014

(30) Foreign Application Priority Data
Nov. 19, 2013 (KR) 10-2013-0140947

(51) Int. Cl. F16D 57/00; F16D 65/14

(52) U.S. Cl. CPC F16D 57/002; F16D 65/14; F16D 2121/20
USPC 188/161

(57) ABSTRACT

A variable braking system may include an outer wheel, a wheel hub, a magnet, a coil, a brake pedal sensor, an electrorheological (ER) fluid, and an electricity supplying unit. The wheel hub may have a wheel flange, be rotatably coupled with the outer wheel and form a braking chamber together with the outer wheel. The magnet may be coupled to the wheel hub in the braking chamber. The coil in the braking chamber may be coupled to the outer wheel to generate current by the magnet when the wheel hub rotates. The brake pedal sensor may output a first signal by detecting an actuation angle of a brake pedal. The ER fluid may be filled in the braking chamber and interfere the rotation of the wheel hub according to selective supply of electricity to the ER fluid. The electricity supplying unit may selectively supply electricity to the ER fluid according to the first signal of the brake pedal sensor.

### CROSS-REFERENCE TO RELATED APPLICATION

The present application claims priority of Korean Patent Application Number 10-2013-0140947 filed on Nov. 19, 2013, the entire contents of which application are incorporated herein for all purposes by this reference.

### BACKGROUND OF INVENTION

1. Field of Invention

The present invention relates to a variable braking system, and more particularly, to a variable braking system that can ensure a braking capability without increasing capacities of a brake disk, a brake pad, a brake booster, and the like.

2. Description of Related Art

A braking system applied to a vehicle basically includes a brake booster increasing step force of a brake pedal, a brake disk which rotates together with a wheel, a brake pad that decreases the speed of a vehicle in contact with the brake disk at pressure doubled in the brake booster, and the like.

However, a braking distance of the vehicle is proportional to a square of the speed of the vehicle and capacities of the brake booster, the brake disk, the brake pad, a tire, and the like need to be increased in order to ensure an appropriate braking distance.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a variable braking system capable of increasing braking performance without increasing capacities of parts such as a brake booster, a brake disk, a brake pad, a tire, and the like.

Various aspects of the present invention provide a variable braking system, including: an outer wheel; a wheel hub having a wheel flange, rotatably coupled with the outer wheel, and forming a braking chamber together with the outer wheel; a magnet coupled to the wheel hub in the braking chamber; a coil coupled to the outer wheel to generate current by the magnet when the wheel hub rotates, in the braking chamber; a brake pedal sensor outputting a first signal by detecting an actuation angle of a brake pedal; an electrorheological (ER) fluid filled in the braking chamber and interfering the rotation of the wheel hub according to selective supply of electricity to the ER fluid; and an electricity supplying unit selectively supplying electricity to the ER fluid according to the signal of the brake pedal sensor.

The variable braking system may further include an insulator covering the coil to insulate the coil from the ER fluid. The electricity supplying unit may include a controller that determines whether current is supplied to the ER fluid and a supply current amount by receiving the first signal of the brake pedal sensor and transfers the determined supply current to the ER fluid.

The variable braking system may further include a battery storing the current supplied from the coil, and the controller may selectively store the current supplied from the coil in the battery or transfer the current to the ER fluid according to the first signal of the brake pedal sensor. The variable braking system may further include a vehicle speed sensor outputting a second signal by detecting the vehicle speed, and the controller may selectively store the current supplied from the coil in the battery or transfer the current to the ER fluid according to the second signal of the vehicle speed sensor and/or the first signal of the brake pedal sensor.

The controller may store the current supplied from the coil in the battery according to the second signal of the vehicle speed sensor and/or the first signal of the brake pedal sensor, or transfer the current transferred from the coil and the current stored in the battery to the ER fluid.

Various other aspects of the present invention provide a variable braking system, including: an outer wheel; a wheel hub having a wheel flange, rotatably coupled with the outer wheel, and forming a braking chamber together with the outer wheel; a magnet coupled to the wheel hub in the braking chamber; a coil coupled to the outer wheel to generate current by the magnet when the wheel hub rotates, in the braking chamber; a brake pedal sensor outputting a first signal by detecting an actuation angle of a brake pedal; a vehicle speed sensor outputting a second signal by detecting the vehicle speed; an electrorheological (ER) fluid filled in the braking chamber and interfering the rotation of the wheel hub according to selective supply of electricity to the ER fluid; and an electricity supplying unit selectively supplying electricity to the ER fluid according to the first signal of the brake pedal sensor and/or the second signal of the vehicle speed sensor.

The electricity supplying unit may include a controller that determines whether current is supplied to the ER fluid and a supply current amount by receiving the first signal of the brake pedal sensor and/or the second signal of the vehicle speed sensor and transfers the determined supply current to the ER fluid.

The variable braking system may further include a battery storing the current supplied from the coil, and the controller may store the current supplied from the coil in the battery or transfer the current to the ER fluid according to the input signal of the brake pedal sensor and the signal of the vehicle speed sensor.

The controller may store the current supplied from the coil in the battery according to the signal of the vehicle speed sensor and the signal of the brake pedal sensor, or transfer the current transferred from the coil and the current stored in the battery to the ER fluid.

The variable braking system may further include an insulator covering the coil to insulate the coil from the ER fluid.

By a variable braking system of the present invention, safe driving of a vehicle can be ensured because braking force is variable. Further, by the variable braking system of the present invention, since a braking capability can be ensured without increasing capacities of a brake disk, a brake pad, a brake booster, and the like, cost can be saved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cutout view of an exemplary variable braking system according to the present invention.

FIG. 2 is an enlarged diagram of part A of FIG. 1.

FIG. 3 is a cross-sectional view taken along line of FIG. 1.

FIG. 4 is an enlarged diagram of part B of FIG. 3.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In the following detailed description, only certain exemplary embodiments of the present invention have been shown and described, simply by way of illustration. As those skilled in the art would realize, the described embodiments may be modified in various different ways, all without departing from the spirit or scope of the present invention Like reference numerals designate like elements throughout the specification. In the drawings, the thickness of layers, films, panels, regions, etc., are exaggerated for clarity. In the specification, unless explicitly described to the contrary, the word “comprise” and variations such as “comprises” or “comprising”, will be understood to imply the inclusion of stated elements but not the exclusion of any other elements.

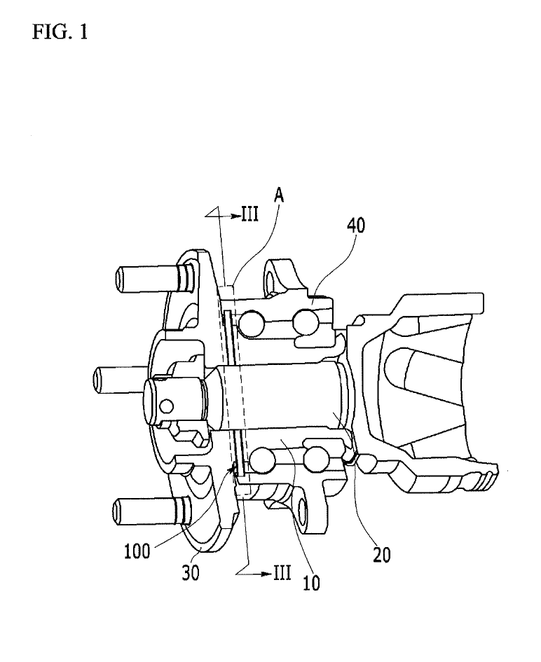

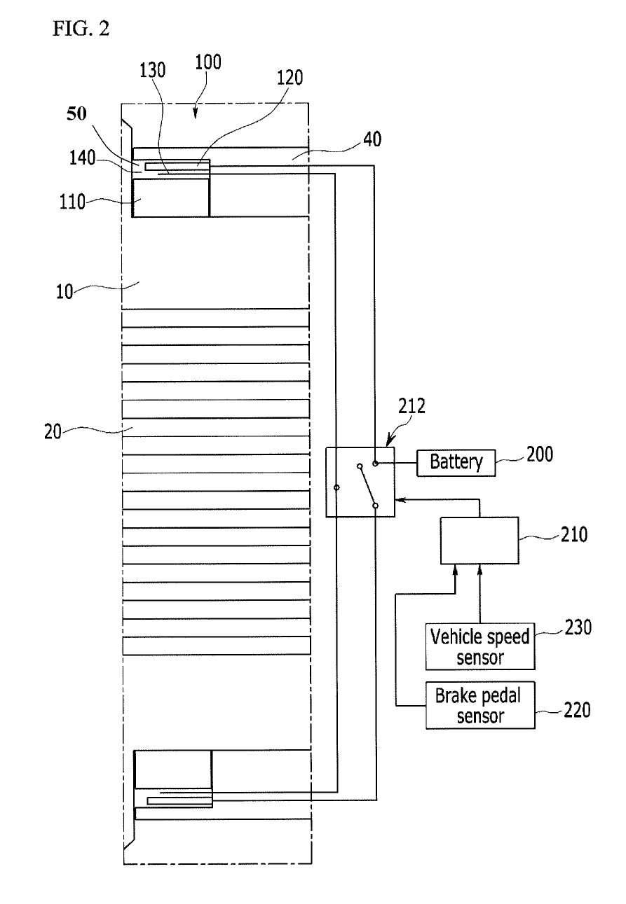

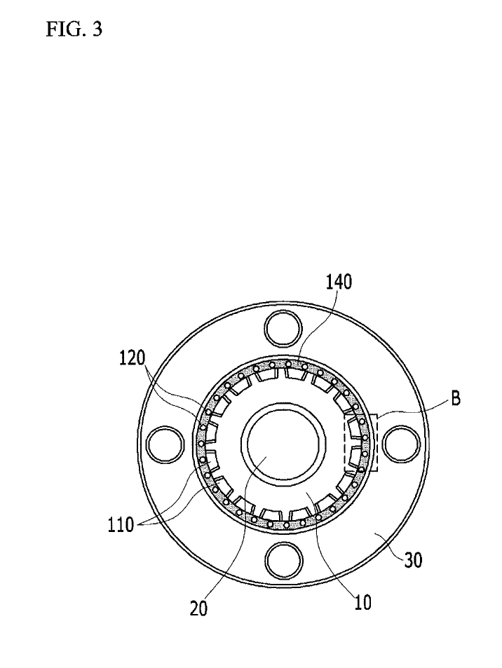

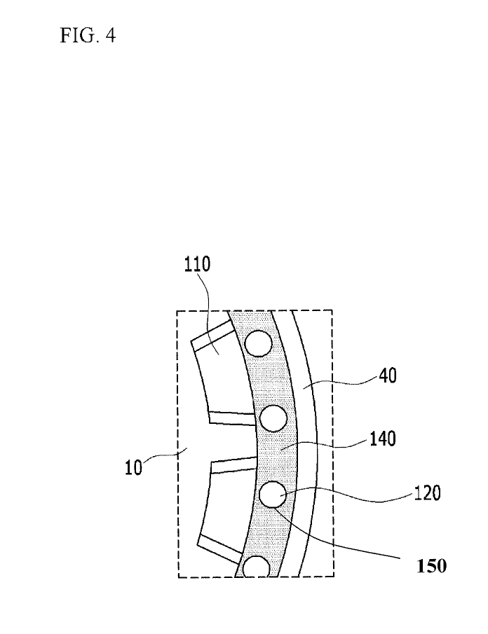

FIG. 1 is a cutout view of a variable braking system according to various embodiments of the present invention, and FIG. 2 is an enlarged diagram of part A of FIG. 1. FIG. 3 is a cross-sectional view taken along line of FIG. 1, and FIG. 4 is an enlarged diagram of part B of FIG. 3.

Referring to FIGS. 1 to 4, the variable braking system 100 according to various embodiments of the present invention includes an outer wheel 40, a wheel hub 10 having a wheel flange 30, rotatably coupled with the outer wheel 40, and forming a braking chamber 50 together with the outer wheel 40, a magnet 110 coupled to the wheel hub 10 in the braking chamber 50, a coil 120 coupled to the outer wheel 40 to generate current by the magnet 110 when the wheel hub 10 rotates, in the braking chamber 50, a brake pedal sensor 220 outputting a corresponding signal by detecting an actuation angle of a brake pedal, an electrorheological (ER) fluid 140 filled in the braking chamber 50 and interfering the rotation of the wheel hub 10 according to selective supply of electricity, and an electricity supplying unit selectively supplying electricity to the electrorheological fluid 140 according to the signal of the brake pedal sensor 220.

Herein, the variable braking system 100 may be applied to a driven wheel and may be applied even to a driving wheel with a drive shaft 20.

The ER fluid includes particles having a size of several microns and is actuated at a power of approximately 2 to 25 V as a material which is not influenced by impurities. The ER fluid is a material in which the density of a liquid is substantially changed to a solid state while the particles react according to a magnetic field generated by power supply such as at 1/several thousand seconds and a motion of the ER fluid is variably controlled by using such a property.

The variable braking system may further include an insulator 150 covering the coil to insulate the coil from the ER fluid 140 and the insulator 150 may be coated on the coil.

The electricity supplying unit includes the controller 210 that determines whether current is supplied to the ER fluid 140 and a supply current amount by receiving the signal of the brake pedal sensor 220 and transfers the determined supply current to the ER fluid.

The variable braking system further includes a battery 200 storing the current supplied from the coil and the controller 210 may store the current supplied from the coil 120 according to the input signal of the brake pedal sensor 220 in the battery 200 or transfer the current to the ER fluid 140.

The variable braking system further includes the vehicle speed sensor 230 that outputs the corresponding signal by detecting a vehicle speed and the controller 210 may store the current supplied from the coil 120 in the battery 200 according to the signal of the vehicle speed sensor 230 and the signal of the brake pedal sensor 220 or transfer the current to the ER fluid 140.

The controller 210 may store the current supplied from the coil 120 in the battery 200 according to the signal of the vehicle speed sensor 230 and the signal of the brake pedal sensor 220 or transfer the current transferred from the coil 120 and the current stored in the battery 200 to the ER fluid 140.

Herein, the controller 210 controls actuation of a switch 212 that selectively connects a current supply line 130 for supplying the electricity to the ER fluid 140, the coil 120, or the battery 200.

Hereinafter, actuation of the variable braking system according to various embodiments of the present invention will be described with reference to the drawings.

When a vehicle is driven, a relative speed difference between the outer wheel 40 and the wheel hub 10 is generated and current flows on the coil 120 by a magnetic field of the magnet 110. Since such a current generation principle is the same as that of a general generator, a detailed description of the principle will be omitted.

The controller 210 determines whether the electricity is supplied to the ER fluid 140 based on the signal input from the brake sensor 220. For example, the controller 210 does not supply the electricity to the ER fluid 140 while the brake pedal is not actuated based on the signal of the brake sensor 220. In this case, the electricity generated from the coil 120 may be stored in the battery 200.

When the controller 210 senses the actuation of the brake pedal from the signal of the brake sensor 220, the controller 210 supplies the electricity generated from the coil 120 to the ER fluid 140.

When the electricity is supplied to the ER fluid 140, the ER fluid 140 is solidified to reduce a relative speed between the wheel hub 10 and the outer wheel 40. Therefore, the speed of the vehicle may be reduced. Herein, the variable braking system assists a brake system of a general vehicle to provide braking force to the vehicle.

As the relative speed difference between the hub 10 and the outer wheel 40 increases, large current is generated, and as a result, as the speed is high, the braking force by the variable braking system may be increased. Further, since the hub 10 is directly braked, braking stability may be maintained.

Further, the controller 210 may calculate braking force required for a current vehicle based on the signal transferred from the brake sensor 220 and the signal of the vehicle speed sensor 230 and determine the electricity supply amount transferred to the ER fluid 140 according to the calculated value. Herein, a solidification degree of the ER fluid 140 is determined according to the transferred current to cope with required braking force.

When a current to be transferred to the ER fluid 140 according to the signal of the vehicle speed sensor 230 and the signal of the brake pedal sensor 220 is larger than the current generated in the coil 120, the controller 210 may transfer the current to the ER fluid 140 by using the electricity stored in the battery 200 together.

On the contrary, when the current generated in the coil 120 is larger than the current to be transferred to the ER fluid 140 according to the signal of the vehicle speed sensor 230 and the signal of the brake pedal sensor 220, that is, when there is an extra of the current generated in the coil 120, the controller 210 may store spare electricity in the battery 200.

According to the variable braking system of the present invention, braking force is provided by assisting a general braking system to ensure stable braking force and ensure variable braking force depending on a vehicle speed by using current of a coil increased with the vehicle speed.

Further, by the variable braking system according to the exemplary embodiment of the present invention, since the generated electricity may be stored or used while the brake is not actuated, fuel efficiency may be improved. Further, by the variable braking system according to the exemplary embodiment of the present invention, when required braking force is large, the braking force may be ensured by additionally using the stored electricity. Further, by the variable braking system according to the exemplary embodiment of the present invention, since a braking capability can be ensured without increasing capacities of a brake disk, a brake pad, a brake booster, and the like, cost can be saved.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A variable braking system, comprising
an outer wheel;
a wheel hub having a wheel flange, rotatably coupled with the outer wheel, and forming a braking chamber together with the outer wheel;
a magnet coupled to the wheel hub in the braking chamber;
a coil coupled to the outer wheel to generate current by the magnet when the wheel hub rotates, in the braking chamber;
a brake pedal sensor outputting a first signal by detecting an actuation angle of a brake pedal;
an electrorheological (ER) fluid filled in the braking chamber and interfering the rotation of the wheel hub according to selective supply of electricity to the ER fluid; and
an electricity supplying unit selectively supplying electricity to the ER fluid according to the first signal of the brake pedal sensor.

2. The system of claim 1, further comprising:
an insulator covering the coil to insulate the coil from the ER fluid.

3. The system of claim 2, wherein the electricity supplying unit includes a controller that determines whether current is supplied to the ER fluid and a supply current amount by receiving the first signal of the brake pedal sensor and transfers the determined supply current to the ER fluid.

4. The system of claim 3, further comprising:
a battery storing the current supplied from the coil, wherein the controller selectively stores the current supplied from the coil in the battery or transfers the current to the ER fluid according to the first signal of the brake pedal sensor.

5. The system of claim 4, further comprising:
a vehicle speed sensor outputting a second signal by detecting the vehicle speed, wherein the controller selectively stores the current supplied from the coil in the battery or transfers the current to the ER fluid according to the second signal of the vehicle speed sensor and/or the first signal of the brake pedal sensor.

6. The system of claim 5, wherein:
the controller stores the current supplied from the coil in the battery according to the second signal of the vehicle speed sensor and/or the first signal of the brake pedal sensor, or
transfers the current transferred from the coil and the current stored in the battery to the ER fluid.

7. A variable braking system comprising:
an outer wheel;
a wheel hub having a wheel flange, rotatably coupled with the outer wheel, and forming a braking chamber together with the outer wheel;
a magnet coupled to the wheel hub in the braking chamber;
a coil coupled to the outer wheel to generate current by the magnet when the wheel hub rotates, in the braking chamber;
a brake pedal sensor outputting a first signal by detecting an actuation angle of a brake pedal;
a vehicle speed sensor outputting a second signal by detecting the vehicle speed;
an electrorheological (ER) fluid filled in the braking chamber and interfering the rotation of the wheel hub according to selective supply of electricity to the ER fluid; and
an electricity supplying unit selectively supplying electricity to the ER fluid according to the first signal of the brake pedal sensor and/or the second signal of the vehicle speed sensor.

8. The system of claim 7, wherein the electricity supplying unit includes a controller that determines whether current is supplied to the ER fluid and a supply current amount by receiving the first signal of the brake pedal sensor and/or the second signal of the vehicle speed sensor and transfers the determined supply current to the ER fluid.

9. The system of claim 8, further comprising:
a battery storing the current supplied from the coil, wherein the controller selectively stores the current supplied from the coil in the battery or transfers the current to the ER fluid according to the first signal of the brake pedal sensor and/or the second signal of the vehicle speed sensor.

10. The system of claim 9, wherein:
the controller stores the current supplied from the coil in the battery according to the second signal of the vehicle speed sensor and/or the first signal of the brake pedal sensor, or
transfers the current transferred from the coil and the current stored in the battery to the ER fluid.

11. The system of claim 7, further comprising:
an insulator covering the coil to insulate the coil from the ER fluid.
